(19) United States
(12) Patent Application Publication
(10) Pub. No.: US 2002/0087320 A1
(43) Pub. Date: Jul. 4, 2002

(54) Computer-implemented fuzzy logic based data verification method and system

(76) Inventors: Victor Wai Leung Lee, Waterloo (CA); Otman A. Basir, Kitchener (CA); Fakhreddine O. Karray, Waterloo (CA); Jiping Sun, Waterloo (CA); Xing Jing, Waterloo (CA)

Correspondence Address: Jones, Day, Reavis and Pogue, North Point, 901 Lakeside Avenue, Cleveland, OH, 44114, US

(21) Appl. No.: 09/863,418

(22) Filed: May 23, 2001

Related U.S. Application Data
(60) Provisional application No. 60/258,911, filed on Dec. 29, 2000.

(51) Int. Cl. G10L 21/00

(52) U.S. Cl. 704/270

(57) ABSTRACT

A computer-implemented method and system for processing requests voiced by a user. User speech input is received that contains words from the user that are directed to at least one concept. The user speech input contains a request for a service to be performed. Speech recognition of the user speech input generates recognized words. The concept of the user speech input is determined by applying fuzzy logic rules to the recognized words. The fuzzy logic rules define non-crisp relationships among predetermined concepts. The user's request is processed based upon the determined concept of the user speech input.

### RELATED APPLICATION

This application claims priority to U.S. Provisional Application Serial No. 60/258,911 entitled “Voice Portal Management System and Method” filed Dec. 29, 2000. By this reference, the full disclosure, including the drawings, of U.S. Provisional Application Serial No. 60/258,911 are incorporated herein.

### FIELD OF THE INVENTION

The present invention relates generally to computer speech processing systems and more particularly, to computer systems that recognize speech.

### BACKGROUND AND SUMMARY OF THE INVENTION

Speech recognition systems are increasingly being used in telephony computer service applications because such systems provide a more natural way for people to acquire information. For example, speech recognition systems are used in telephony applications where a user through a communication device requests that a service be performed. The user may be requesting weather information to plan a trip to Chicago. Accordingly, the user may ask what the temperature is expected to be in Chicago on Monday.

The range of user requests and the variety of different ways in which users may phrase their particular request frustrate many speech recognition systems. The difficulties lie not only in recognizing the actual text of the user's request, but also in understanding what the text of the request means and how to process and adequately respond to the request. The present invention addresses the ever-changing ways in which users voice their requests. In accordance with the teachings of the present invention, a computer-implemented method and system are provided for processing requests voiced by a user. User speech input is received that contains words from the user that are directed to at least one concept. The user speech input contains a request for a service to be performed. Speech recognition of the user speech input generates recognized words. The concept of the user speech input is determined by applying fuzzy logic rules to the recognized words. The fuzzy logic rules define non-crisp relationships among predetermined concepts. The user's request is processed based upon the determined concept of the user speech input.

Further areas of applicability of the present invention will become apparent from the detailed description provided hereinafter. It should be understood however that the detailed description and specific examples, while indicating preferred embodiments of the invention, are intended for purposes of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description and the accompanying drawings, wherein:

FIG. 1 is a system block diagram depicting the computer and software-implemented components used by the present invention for speech recognition;

FIG. 2 is a system-level flowchart depicting exemplary speech recognition processing by the present invention;

FIG. 3 is a block diagram depicting rules used by the present invention to process the exemplary user speech input;

FIG. 4 is a block diagram depicting the web summary knowledge database for use in speech recognition;

FIG. 5 is a block diagram depicting the conceptual knowledge database unit for use in speech recognition; and

FIG. 6 is a block diagram depicting the user profile database for use in speech recognition.

### DETAILED DESCRIPTION OF THE PREFERRED EMBODIMENT

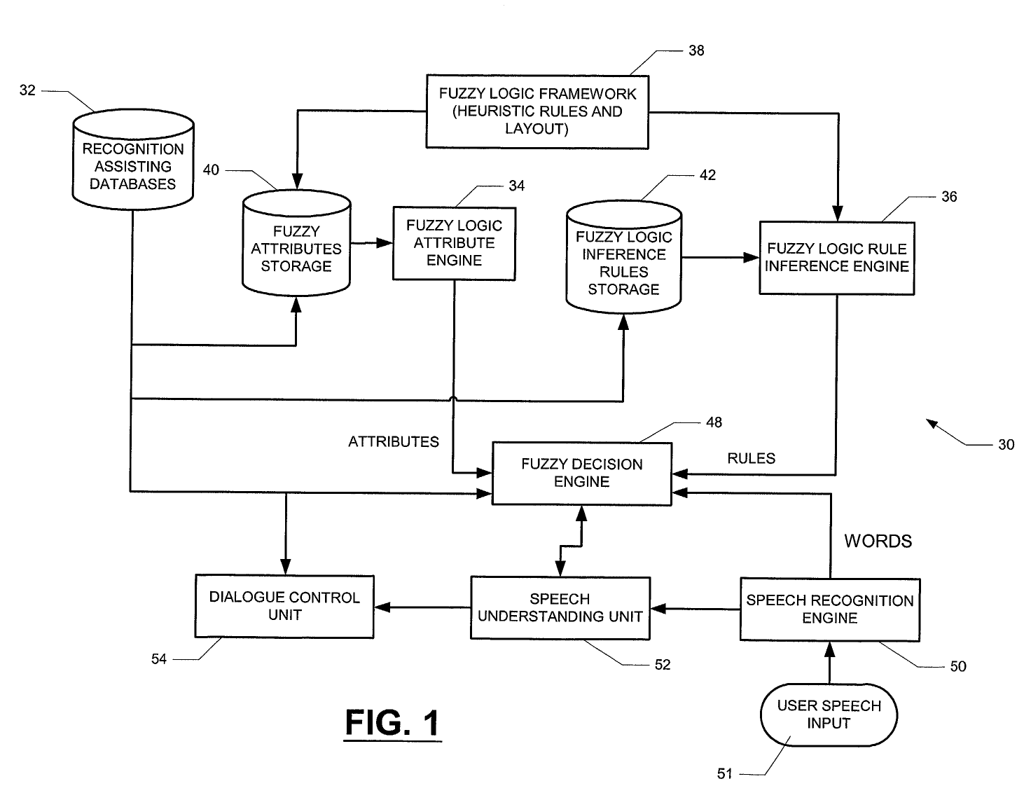

FIG. 1 depicts the fuzzy logic based data verification system 30 of the present invention. With reference to FIG. 1, the fuzzy logic based data verification system 30 makes inferences about the meaning of speech input 51 from a user. Fuzzy logic attributes and fuzzy inference rules are combined in a fuzzy decision engine 48 for a comprehensive analysis of the user speech input 51. The analysis is used in the determination of the understanding of what the user has spoken.

Fuzzy inference rules define non-crisp relationships among concepts and are stored in the fuzzy inference rules storage unit 42. Fuzzy attributes, on the other hand, define types of information contained within each concept, and these attributes are stored in the fuzzy attributes storage unit 40. Attributes are fuzzy in the sense that such attributes are used in a fuzzy inference. Fuzzy attributes can take on multiple values and each value may have its own weighting or probability assigned. For example, fuzzy attributes of some concept, such as the concept PERSON, can be [name] or [profession]. The [name] attribute could hold the value “John.” The [profession] attribute can hold the value “lawyer.” As another example, for the concept CALL, the word “John” can be the value for the [callee] attribute, the word “cell-phone” can be the value of the [phone-kind] attribute, and the word “7753421” can be the value stored in the [phone-number] attribute.

A fuzzy inference rule has the following general format:

Premise: [concept]

[attribute value]

Consequent:

[decision]

[certainty=numeric value]

As an example of an inference rule, consider the concept CONTACT that can be expressed by the words “contact” or “reach.”. The fuzzy inference rules infer implications from general concepts such as CONTACT. In this example, CONTACT implies concrete concepts such as CALL-THROUGH-TELEPHONE, SEND-EMAIL, SEND-FAX, etc.

It should be noted that the present invention embodies and exploits fuzzy concepts on multiple levels. For example, in response to the user inquiry, “Where can I contact John?” the system determines that partly because of the time of day and the use of the term “contact,” the most likely manner in which to successfully communicate with John would be to telephone him at his office. The present invention employs a probability that John was at his office telephone based upon all the information available. The probability assigned takes into account the possibility that John is not in fact where the system predicted.

The present invention deals with uncertainty at a second level when processing user requests. The present invention determines that the request to “contact” John meant that the user wanted to speak with John over the telephone. This uncertainty is dealt with by the present invention by discerning the core of the user's request by evaluating the structure of the request and the particular words used before formulating a response. Such evaluation takes place in the speech understanding unit 52.

The fuzzy logic attributes and fuzzy inference rules are derived from Internet web pages. Information about the Internet web pages is stored in the recognition assisting databases 32. Such stored information includes how words are used on the Internet web pages, associations between frequency of words and the topics of the web pages, web page topology and other such related information.

When discerning how words are used on the Internet web pages, the invention uses the characteristic of human languages that words are linked to other words. Because words represent concepts, concepts may also be linked to other concepts. Some links derive attributes for words; other links derive inference rules. For example, from the web page sentence “the company's contact number is 3345677,” the system derives an attribute “contact number” for the concept “company.” As an example of deriving fuzzy inference rules, consider the sentence “we contacted the company through email.” The fuzzy inference rule derived infers that “contacting” can be done by “sending email”. The fuzzy logic framework 38 stores hand-made heuristic patterns used for inducing actual attributes and rules. The fuzzy logic attribute engine 34 and the fuzzy logic rule inference engine 36 select appropriate attributes and rules and make inferences. The fuzzy decision engine 48 combines the results of the previous two engines (34 and 36) in the final inference process to make decisions about the problems raised by either speech understanding unit 52 and the dialogue control unit 54. The speech understanding unit 52 uses the fuzzy-derived results to understand what the user has most recently spoken. The dialogue control unit 54 uses the fuzzy-derived results to understand what the user has most recently spoken in relation to other dialogues with the user. The dialogue control unit 54 may use a profile of the user (as well as other users) to better understand what the user has mentioned in relation to previous conversations. Such user profile information is stored in the recognition assisting databases 32.

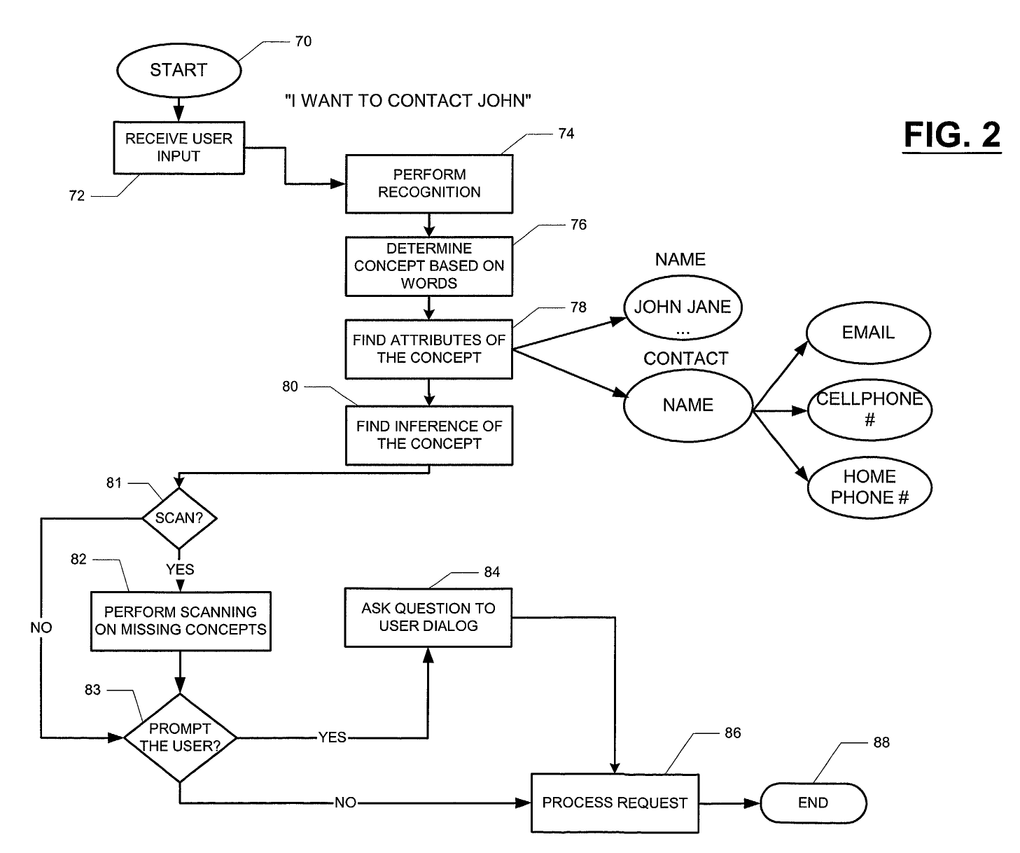

FIG. 2 illustrates the process of fuzzy-logic based inference. The start block 70 initiates the process of understanding a user speech input as a request for a particular service. The user speech input is received at process block 72. Process block 74 performs speech recognition to transfer voice information into text information in the form of word sequences. Process block 76 searches the word sequence to find words that represent concepts or keyword messages. This may be performed by looking up a word-to-concept mapping lexicon. Process block 78 determines the attributes of concepts. Each concept has a set of fuzzy attributes, describing what attributes a concept possesses, what types of words can be its attributes, and to what degree (note that the attribute structures are contained in the fuzzy attribute storage of block 40 FIG. 1). Attributes of the concepts are found either by directly searching for certain words in the user speech input or by performing inference based on the context.

Process block 80 does the inference using inference rules. The fuzzy inference rule links concepts, in the form of membership functions. For example, the inference engine, using inference rules, may infer:

CONTACT(John)=>phone-call (0.6), email (0.3), fax(0.1)

The numbers in the parentheses denote the likelihood of participation in the membership function. The CONTACT rule connects the name concept (such as John) to other concepts (such as phone, email and fax). The connection is defined by words relating to a CONTACT inference (such as “call”, “send this email”. . . etc.), which defines the path linked between concepts such as NAME and PHONE. The linkage is established if the word “call” is recognized by the speech recognition unit. With this linkage, the system expects the attribute of each concept to be fulfilled, by recognizing words on the person's name and the phone number. If decision block 81 does not detect in speech recognition a name, then process block 82 is executed in order to perform a phonetic scanning for the phonemes that have been recognized after the word “contact” in the utterance. If decision block 83 determines that a name such as John has been recognized with high enough confidence (e.g., above 60% probability or another probability that suits the situation at hand), then the fuzzy inference process has completed, and at process block 86 the result is transferred into a command expression which relays this information to the speech understanding unit and dialogue control unit to process the user's request. Processing then terminates at end block 88.

However if phonetic scanning is unsuccessful at process block 82, then at decision block 83 the inference engine will initiate an interaction process to ask the user to give a person name with the question “whom do you want to contact”. This user interaction is carried out at the process block 84. With the missing information supplied, process block 86 processes the request before processing terminates at end block 88.

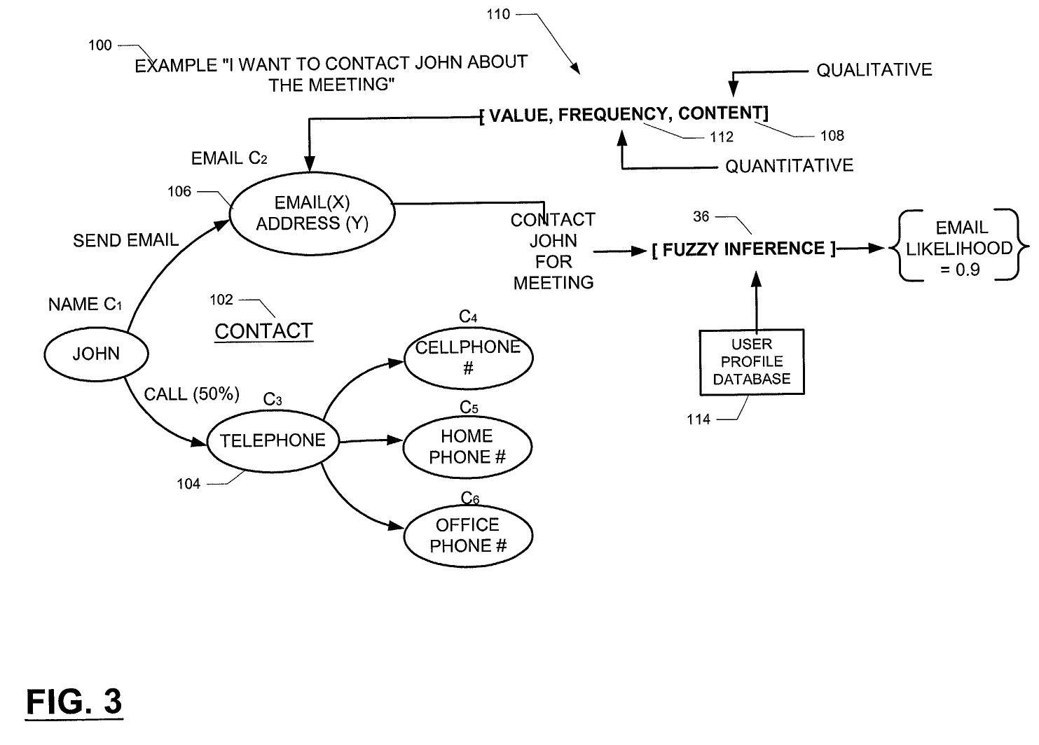

FIG. 3 depicts an exemplary use of attributes in the fuzzy inference process. This is shown by the example utterance 100 containing the phrase “I want to contact John about the meeting.” As described above, the inference engine infers from the concept CONTACT 102 an implication of either TELEPHONE-CALL 104 or SEND-EMAIL 106. At this point in this example, the system selects between two strategies: one is to ask the user to select a means of communication with a preference for using the telephone; the other is to ask the user what message he wants to send to John. In the latter strategy, further inference may be based on the content of the message. This occurs because the “[content]” attribute 108 is actually an attribute of the concept SEND-EMAIL 106. An exemplary attribute structure for the SEND-EMAIL concept 106 is depicted at 110 as

[addressee (i.e., value), frequency, content]

where frequency 112 is a quantitative value based on data in a user profile database 114, showing how frequently this user likes to use electronic mail to contact people. The [content] attribute 108 is a qualitative attribute showing the type of message that is sent. The fuzzy inference engine 36 processes SEND-EMAIL concept by using the rule CONTACT(Value=Person, Frequency=>0.5, Content=Business)=>Email(>0.8). This means if the contact is a person, the user profile frequency is often enough (say more than 50 percent) and the content is about business, then the conclusion that the user wishes to contact via email is a likely option.

Words expressing the [content] attribute, such as “notice”, “letter”, “report”, “briefing”, “schedule”, have different membership functions to different concepts. For example, “notice” or “schedule” may be highly related to PHONE-CALL's [content] attribute because sending a notice is relatively easily done by phone calls, while a letter is more appropriately sent through email. If in response to an inquiry the user answers “tell John about my schedule,” then the inference engine infers the appropriate means of communication should be giving him a phone call.

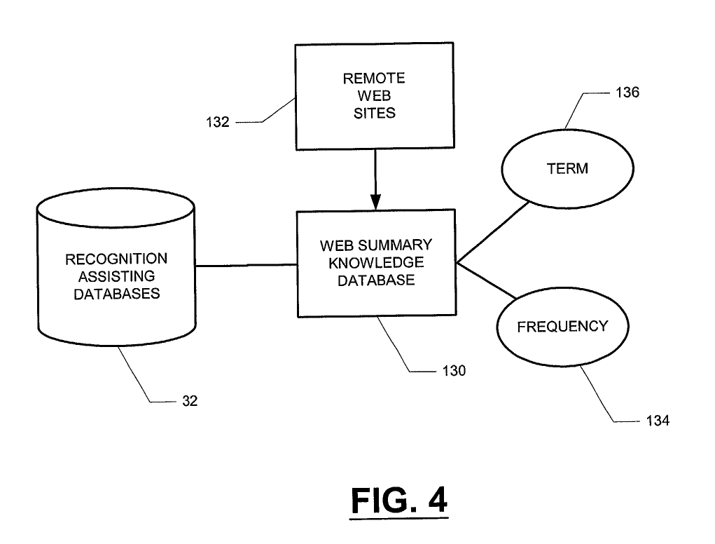

FIG. 4 depicts the web summary knowledge database 130 that forms one of the speech recognition assisting databases 32. The web summary information database 130 contains terms and summaries derived from relevant web sites 132. The web summary knowledge database 130 contains information that has been reorganized from the web sites 132 so as to store the topology of each remote web site 132. Using structure and relative link information, the web summary knowledge database 130 filters out irrelevant and undesirable information including figures, ads, graphics, Flash content, Java applets, and JavaScript commands. The remaining content of each page is categorized, classified and itemized. Through what terms/words are used on the web sites 132, the web summary database 130 determines the frequency 134 with which a term 136 has appeared on the web sites 132. For example, the web summary database may contain a summary of the Amazon.com web site and determines the frequency with which the term golf appeared on the web site.

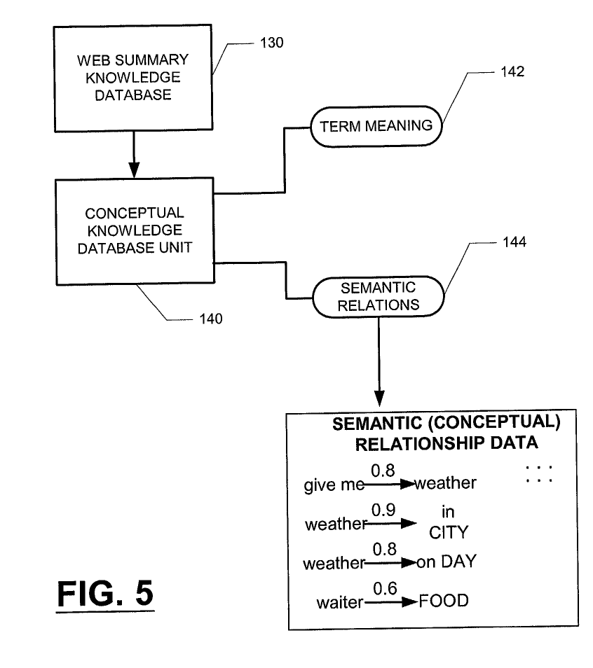

FIG. 5 depicts the conceptual knowledge database unit 140 that forms one of the speech recognition assisting databases 32. The conceptual knowledge database unit 140 encompasses the comprehension of word concept structure and relations and derives its information from the word usage data of the web summary knowledge database 130. The conceptual knowledge database unit 140 understands the meanings 142 of terms in the corpora and the semantic relationships 144 between terms/words.

The conceptual knowledge database unit 140 provides a knowledge base of semantic relationships among words, thus providing a framework for understanding natural language. For example, the conceptual knowledge database unit 140 may contain an association (i.e., a mapping) between the concept “weather” and the concept “city”. These associations are formed by scanning the web summary knowledge database engine 130, to obtain conceptual relationships between words and categories, and by their contextual relationship within sentences.

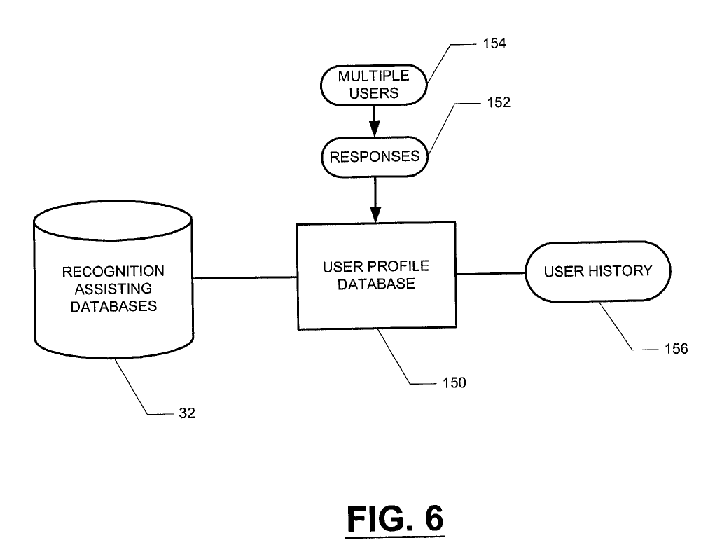

FIG. 6 depicts the user profile database 150 that forms one of the recognition assisting databases 32. The user profile database 150 contains data compiled from multiple users' histories that has been calculated for the prediction of likely user requests. The histories are compiled from the previous responses 152 of the multiple users 154. Users belong to various user groups, distinguished on the basis of past behavior, and can be predicted to produce utterances containing keywords and concepts, for example, for shopping or weather related services. The present invention also uses the response history 156 for a particular user in recognizing and understanding the words of that user.

The preferred embodiment described within this document with reference to the drawing figures is presented only to demonstrate an example of the invention. Additional and/or alternative embodiments of the invention will be apparent to one of ordinary skill in the art upon reading this disclosure.

It is claimed:

1. A computer-implemented method for processing requests voiced by a user, comprising the steps of:
receiving user speech input that contains words from the user that are directed to at least one concept, said user speech input containing a request for a service to be performed;
performing speech recognition of the user speech input to generate recognized words;
determining the concept of the user speech input by applying fuzzy logic rules to the recognized words, said fuzzy logic rules defining non-crisp relationships among predetermined concepts; and
processing the user's request based upon the determined concept of the user speech input.
